(19) United States
(12) Patent Application Publication
(10) Pub. No.: US 2016/0119727 A1
(43) Pub. Date: Apr. 28, 2016

(54) SINTER BONDED MU-METAL RECEIVER CAN

(71) Applicant: Sidney A. Higgins, Maple Grove, MN (US)

(72) Inventor: Sidney A. Higgins, Maple Grove, MN (US)

(21) Appl. No.: 14/919,333

(22) Filed: Oct. 21, 2015

Related U.S. Application Data
(60) Provisional application No. 62/069,042, filed on Oct. 27, 2014.

(51) Int. Cl. H04R 25/00; H04R 25/02

(52) U.S. Cl. CPC H04R 25/608; H04R 25/02; H04R 25/65; H04R 2225/021; H04R 2225/59; H04R 2225/49

(57) ABSTRACT

A receiver can for containing a hearing aid receiver within the housing of a hearing aid is described. The receiver can may be made of Mu-metal to provide magnetic shielding. A sintering process may be used to construct the receiver can by sintering two halves of the can together.

### CLAIM OF PRIORITY

This patent application claims the benefit of U.S. Provisional Patent Application No. 62/069,042, filed Oct. 27, 2014, entitled “SINTER BONDED METAL RECEIVER CAN”, which is incorporated by reference herein in full.

### FIELD OF THE INVENTION

This invention pertains to electronic hearing aids and methods for their construction.

### BACKGROUND

Hearing aids are electroacoustic device which amplify sound for the wearer in order to correct hearing deficits. Certain types of hearing aids, referred to as behind-the-ear (BTE) hearing aids, utilize a housing that is worn behind the ear that contains, among other things, a receiver (i.e., loudspeaker) that conducts sound to an earbud inside the ear via an audio tube. The receiver is a source of magnetic radiation that may affect other components inside the housing such as the processing circuitry or a telecoil used to receive audio signals from a magnetic source such as a telephone.

### BRIEF DESCRIPTION OF THE DRAWINGS

FIG. 1 shows the basic electronic components of an example hearing aid.

FIGS. 2 and 3 show embodiments of a BTE hearing aid in cross-section.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

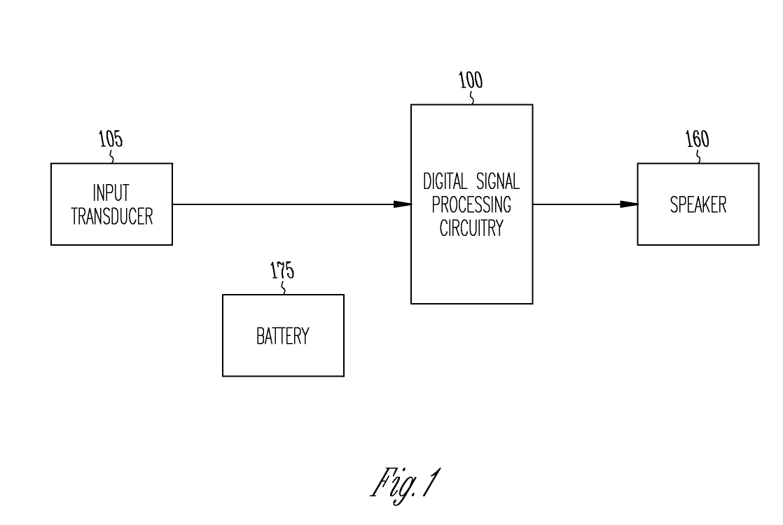

FIG. 1 illustrates the basic functional components of an example hearing aid. Hearing aids are devices that compensate for hearing losses by amplifying sound whose electronic components include a microphone for receiving ambient sound, an amplifier for amplifying the microphone signal in a manner that depends upon the frequency and amplitude of the microphone signal, a speaker for converting the amplified microphone signal to sound for the wearer, and a battery for powering the components. The electronic circuitry of the hearing aid is contained within a housing that may be placed, for example, in the external ear canal or behind the ear. An input transducer (i.e., microphone) 105 receives sound waves from the environment and converts the sound into an input signal. After amplification by a pre-amplifier, the input signal is sampled and digitized to result in a digitized input signal that is passed to processor 100. The processor 100 processes the digitized input signal into an output signal in a manner that compensates for the patient's hearing deficit (e.g., frequency-specific amplification and compression). The output signal is then converted to analog form and passed to an audio amplifier that drives a receiver 160 (a.k.a. a loudspeaker) to convert the output signal into an audio output. A battery 175 supplies power for the electronic components. In a BTE hearing aid, the receiver 160 may be contained in the housing worn behind the ear. An acoustic path is provided for sound produced by receiver that may include an audio tube connected to an earbud placed in the wearer's ear.

To reduce the magnetic radiation produced by the receiver, the receiver may be contained within a separate housing, referred to as a receiver can, that provides magnetic shielding. Magnetic isolation and efficient space utilization inside a BTE hearing aid, however, is difficult to achieve due to molding constraints and the action of placing a square component on a curved surface. By overcoming the limitations imposed by molding, a receiver can-in-a-can solution may be more efficiently constructed and optimally placed which results in smaller higher gain devices.

In one type of design, an extruded one-piece metal (e.g., Mu-metal or other alloy) is used with receiver suspensions attached to the receiver, but the acoustic port must follow commonly understood molding practices so that trapped steel can be removed during the ejection process. This, however, may result in larger can cover assemblies as well as expensive, non-practical manufacturing solutions like lost wax molding and then plating with metal.

In an alternative design, a metal (e.g., Mu-metal or other alloy) receiver can is molded in two liner halves using metal-injection-molding (MIM). This technique provides the undercuts and usually non-moldable acoustic paths. The two halves may then bonded together using a sintering process. An opening or acoustic path for the receiver can assembly may be placed wherever magnetic radiation simulations dictate and are not restricted by the manufacturing process. This embodiment allows complex internal undercuts and a torturous acoustic internal path or paths inside the metal can and provides a point contact suspension option to the receiver instead of a compressive band around the receiver. This affords more suspension options and consistency and eliminates seams which are opportunities for slit leaks. Also, the acoustic path may be tuned via shape (or shapes) and smoothed via internal radiuses to provide an optimum response. This may eliminate the acoustic re-radiating (pumping effect) that can occur inside a BTE hearing aid. The acoustic path can hug the ear curve and incorporate bends of any angle while optimally placing the assembly.

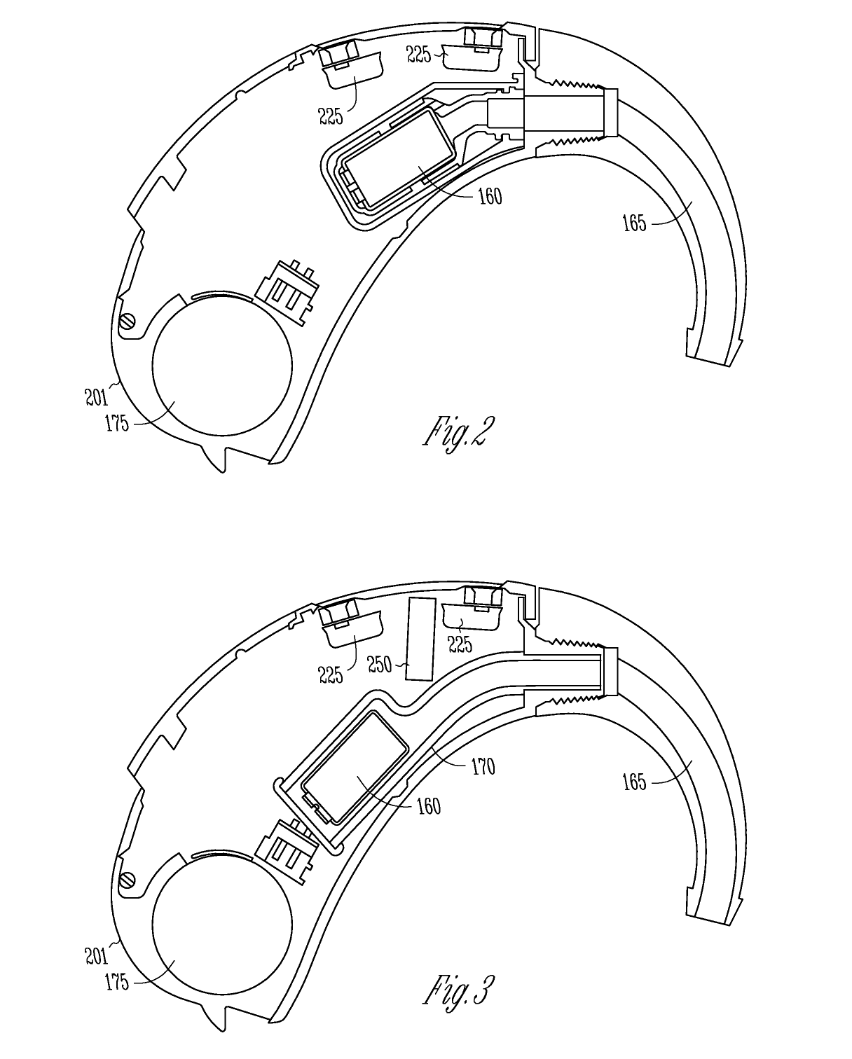

FIGS. 2 and 3 show embodiments of a BTE hearing aid in cross-section that each include a housing 201 that contains a battery 175, a receiver 160, a pair of omnidirectional microphones 225, and an audio tube 165 connected to the device housing for providing an acoustic path from the receiver. In the embodiment shown in FIG. 3, the receiver 160 is contained within a receiver can 170 constructed as described above by sintering two metal halves together. The receiver can 170 may also have an extension that provides an acoustic path to the audio tube 165.

Each half of the receiver can 170 may have corresponding interlock details molded in the green state. The two halves may then be assembled together and placed into the sintering oven. During the sinter process, the polymer binder is burned off, and the powdered metal fuses together. The fusing process has been demonstrated to occur across parting lines which result in a properly annealed homogeneous Mu-metal can.

In the embodiment shown in FIG. 3, there may be approximately 1½ mm additional space below the omnidirectional microphones 225 as compared with FIG. 2. Without moving any other components, a telicoil 250 can be placed between the omnidirectional microphones 225 in an optimized manner for loop and phone usage. In other embodiments, two receivers (e.g., a tweeter and a woofer) and separate acoustic paths could be contained by a single receiver can. A threaded spout could also be added to the receiver can for connecting to the audio tube.

### Example Embodiments

In an example embodiment, a hearing aid comprises: an input transducer for converting an audio input into an input signal; a processor for processing the input signal into an output signal in a manner that compensates for a patient's hearing deficit; an audio amplifier, and a receiver for converting the output signal into an audio output, wherein the receiver is contained in a receiver can as described above.

In one embodiment, the receiver can is constructed by sintering a plurality of metal can portions together. In one example, the receiver can is constructed by sintering two metal halves together. The metal may Mu-metal. The input transducer, processor, receiver, and receiver can may be contained within a device housing. The receiver can may further comprise an acoustic pathway for conducting sound from the receiver. The hearing aid may further comprise an audio tube that provides an acoustic pathway from the housing. The receiver can may further comprise an extension that provides an acoustic pathway to the audio tube. The receiver can may further comprise a threaded spout for connecting to the audio tube. The receiver can may contain two or more receivers. Each half of the receiver can may corresponding interlock details molded therein.

In another embodiment, a method for constructing a hearing aid comprises constructing a hearing aid in accordance with any of the embodiments described above.

Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Such devices may include antenna configurations, which may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the wearer.

It is understood that digital hearing aids include a processor. In digital hearing aids with a processor programmed to provide corrections to hearing impairments, programmable gains are employed to tailor the hearing aid output to a wearer's particular hearing impairment. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing aid, comprising:
an input transducer for converting an audio input into an input signal;
a processor for processing the input signal into an output signal in a manner that compensates for a patient's hearing deficit;
a receiver for converting the output signal into an audio output; and,
a receiver can for containing the receiver, wherein the receiver can is constructed by sintering a plurality of metal can portions together.

2. The hearing aid of claim 1 wherein the receiver can is constructed by sintering two metal halves together.

3. The hearing aid of claim 1 wherein the metal is Mu-metal.

4. The hearing aid of claim 1 wherein the input transducer, processor, receiver, and receiver can are contained within a device housing.

5. The hearing aid of claim 4 wherein the receiver can further comprises an acoustic pathway for conducting sound from the receiver.

6. The hearing aid of claim 4 further comprising an audio tube that provides an acoustic pathway from the housing.

7. The hearing aid of claim 6 wherein the receiver can further comprises an extension that provides an acoustic pathway to the audio tube.

8. The hearing aid of claim 6 wherein the receiver can further comprises a threaded spout for connecting to the audio tube.

9. The hearing aid of claim 1 wherein the receiver can contains two or more receivers.

10. The hearing aid of claim 2 wherein each half of the receiver can has corresponding interlock details molded therein.

11. A method for constructing a hearing aid, comprising:
disposing a receiver and a receiver can for containing the receiver in a device housing; and
constructing the receiver can by sintering a plurality of metal can portions together.

12. The method of claim 11 further comprising constructing the receiver can by sintering two metal halves together.

13. The method of claim 11 wherein the metal is Mu-metal.

14. The method of claim 11 further comprising disposing an input transducer and a processor within the device housing.

15. The method of claim 14 further comprising constructing the receiver can with an acoustic pathway for conducting sound from the receiver.

16. The method of claim 14 further comprising connecting an audio tube to the housing in order to provide an acoustic pathway from the housing.

17. The method of claim 16 further comprising constructing the receiver can with an extension that provides an acoustic pathway to the audio tube.

18. The method of claim 16 further comprising constructing the receiver can with a threaded spout for connecting to the audio tube.

19. The method of claim 11 wherein the receiver can contains two or more receivers.

20. The method of claim 12 wherein each half of the receiver can has corresponding interlock details molded therein.
